(19) United States
(12) Patent Application Publication
(10) Pub. No.: US 2026/0162631 A1
(43) Pub. Date: Jun. 11, 2026

(54) RESIDUAL IMAGE COMPENSATION METHOD, APPARATUS, DISPLAY DEVICE, AND COMPUTER-READABLE STORAGE MEDIUM

(71) Applicant: BOE TECHNOLOGY GROUP CO., LTD., Beijing (CN)

(72) Inventors: Yanhong Wu, Beijing (CN); Ran Duan, Beijing (CN)

(73) Assignee: BOE TECHNOLOGY GROUP CO., LTD., Beijing (CN)

(21) Appl. No.: 18/704,214

(22) PCT Filed: Apr. 28, 2023
(86) PCT No.: PCT/CN2023/091548

§ 371 Date: Apr. 24, 2024

(30) Foreign Application Priority Data
May 30, 2022 (CN) 202210603256.6

(51) Int. Cl. G09G 5/37; G06T 5/80; G06T 7/90; G06V 10/74

(52) U.S. Cl. CPC G09G 5/37; G06T 5/80; G06T 7/90; G06V 10/761; G09G 2320/0242; G09G 2320/0666

(57) ABSTRACT

Embodiments of the present disclosure provide a residual image compensation method and apparatus, a display device, and a computer-readable storage medium. The method includes: obtaining a target image, where the target image is a current frame image for being displayed on a display panel; when a visual content of the target image is displayed on the display panel for a duration that does not exceed a preset duration, determining whether there is a residual image on the display panel; in the case that there is a residual image on the display panel, determining a residual image region of the display panel, and determining a residual image compensation parameter according to a display property of the display panel and image information of an image displayed in the residual image region; performing, according to the residual image compensation parameter, residual image compensation on a next frame image to be displayed.

### TECHNICAL FIELD

The present disclosure relates to the technical field of display, and more particularly, to a residual image compensation method, apparatus, a display device, and a computer-readable storage medium.

### BACKGROUND

A backlight substrate can be directly used as a surface light source in a direct display type backlight source. Generally, the backlight substrate is obtained by splicing Printed Circuit Boards (PCBs) each provided with a Micro-Light Emitting Diode (Micro-LED). However, when a certain grayscale image is displayed for a long time on a display panel provided with the spliced screen, temperature variation occurs in the spliced screen, and the luminous efficiency decreases as the temperature increases, resulting in a residual image on the display panel when the image is switched.

### SUMMARY

Embodiments of the present disclosure provide a residual image compensation method, apparatus, a display device, and a computer-readable storage medium.

In a first aspect, embodiments of the present disclosure provide a residual image compensation method, including:
obtaining a target image, wherein the target image is a current frame image for being displayed on a display panel;
when a visual content of the target image is displayed on the display panel for a duration that does not exceed a preset duration, determining whether there is a residual image on the display panel;
in the case that there is a residual image on the display panel, determining a residual image area of the display panel, and determining a residual image compensation parameter according to a display property of the display panel and image information displayed in the residual image area; and
performing, according to the residual image compensation parameter, residual image compensation on a next frame image to be displayed.

In some embodiments, before the determining whether there is a residual image on the display panel, the method further includes:
obtaining image information of at least one historical frame image adjacent to the target image; and
determining the duration for displaying the visual content of the target image on the display panel according to the image information of at least one historical frame image.

In some embodiments, the determining the duration for displaying the visual content of the target image on the display panel according to the image information of at least one historical frame image, includes:
comparing the at least one historical frame image and the target image, to determine whether there is a switching image, wherein a change in visual content occurs between the switching image and a frame image previous to the switching image;
when there is at least a switching frame image, obtaining a target switching image which is closest to the target image in at least a switching frame image; and
determining a time interval between the target switching image and the target image as the duration for displaying the visual content of the target image on the display panel.

In some embodiments, the comparing the at least one historical frame image and the target image to determine whether there is the switching image includes:
obtaining an average grayscale map of the at least one historical frame image and the target image, wherein the average grayscale map includes number n of grayscale blocks, wherein the number n is a positive integer greater than 1;
with respect to an average grayscale map of every two adjacent frame images in at least one historical frame image and the target image, determining a grayscale difference of grayscale blocks located at a same position in two average grayscale maps;
in the case that each of number n of grayscale differences is less than a preset threshold, determining that there is no switching image; otherwise, determining that a next one in the two adjacent frame images is a switching image.

In some embodiments, the obtaining the average grayscale map of the at least one historical frame image and the target image includes:
with respect to the at least one historical frame image and each frame image of the target image, performing the followings:
converting the image into a grayscale map;
dividing the grayscale map into the number m*m of first regions, wherein each of the first regions includes a plurality of pixels, the number m is an integer greater than 1, and the number n is equal to the number m*m;
determining a grayscale value of each of the first regions according to grayscale values of the plurality of pixels in each of the first regions, wherein the grayscale value of the first region is an average value of the grayscale values of the plurality of pixels;
generating an average grayscale map including the number n of grayscale blocks according to the grayscale value of each of the first regions.

The determining whether there is the residual image on the display panel includes:
generating a reference image according to an image actually displayed on the display panel;
determining at least one first connection region on the target image according to the image information of the target image;
determining a respective second connection region corresponding to each of the first connection regions on the reference image, wherein a coverage area of the second connection region on the reference image is same as a coverage area of the corresponding first connection region on the target image;
determining, according to the image information of the reference image and image information of the target image, gradient information of each of the first connection regions and gradient information of each of the second connection regions;
determining, according to the gradient information of each of the first connection regions and the gradient information of each of the second connection regions, whether there is the residual image in an area corresponding to each of the second connection regions on the display panel.

In some embodiments, the gradient information of the first connection region includes a gradient value of each pixel in the first connection region, and the gradient information of the second connection region includes a gradient value of each pixel in the second connection region;
determining, according to the gradient information of each of the first connection regions and the gradient information of each of the second connection regions, whether there is the residual image in the area corresponding to each of the second connection regions on the display panel includes:
with respect to each of the second connection regions and the first connection region corresponding to the second connection region, performing the followings:
determining a maximum value and a minimum value of a plurality of gradient values in the first connection region, and calculating a first gradient difference between the maximum value and the minimum value;
determining a gradient value of a first pixel and a gradient value of a second pixel in the second connection region; wherein the first pixel is a pixel at a same position as a pixel with the maximum gradient value in the first connection region, and the second pixel is a pixel at a same position as a pixel with the minimum gradient value in the first connection region;
calculating a second gradient difference between the gradient value of the first pixel and the gradient value of the second pixel;
determining whether the difference between the first gradient difference and the second gradient difference is greater than a preset threshold, and if it is, determining that there is the residual image in an area corresponding to the second connection region on the display panel.

In some embodiments, the determining a residual image area of the display panel, includes:
determining a coverage area of all second connection regions corresponding to the residual image as the residual image area.

In some embodiments, before generating the reference image according to the image actually displayed on the display panel, the method further includes:
determining whether a residual image compensation parameter has been determined when a previous frame image is being displayed;
if it is, driving the display panel to display according to image information of an intermediate image, wherein the intermediate image is an image obtained by performing residual image compensation on the target image according to the residual image compensation parameter determined when the previous frame image is being displayed;
if otherwise, driving the display panel to display according to the image information of the target image.

In some embodiments, the generating a reference image according to an image actually displayed on the display panel, includes:
photographing the display panel to obtain an initial photographed image;
performing distortion correction on the initial photographed image to obtain the reference image.

In some embodiments, the residual image area includes at least one sub-area, and each of the at least one sub-area corresponds to a respective one of the second connection regions; and the determining the residual image compensation parameter according to the display property of the display panel and the image information of the image displayed in the residual image area includes:
with respect to each of the at least one sub-area,
obtaining, according to the display property of the display panel, first color coordinates of a plurality of first pixels of the target image in the sub-area and second color coordinates of a plurality of second pixels of the reference image in the sub-area;
calculating an average value of the plurality of first color coordinates to obtain a first target color coordinate;
calculating coordinate differences between the plurality of second color coordinates and the first target color coordinates, and determining a second color coordinate having a largest coordinate difference with respect to the first target color coordinate as the reference color coordinate;
determining the residual image compensation parameter according to a reference RGB value and an initial RGB value of each of the second pixels, wherein the reference RGB value is an initial RGB value of the second pixel corresponding to the reference color coordinates.

In some embodiments, the display property of the display panel includes at least a gamma value and a color coordinate conversion matrix of the display panel;
the obtaining the first color coordinates of the plurality of first pixels of the target image in the residual image area and the second color coordinates of the plurality of second pixels of the reference image in the residual image area according to the display property of the display panel includes:
determining linear RGB values of the plurality of first pixels according to the initial RGB values of the plurality of first pixels and the gamma value;
determining the first color coordinates of the plurality of first pixels according to the linear RGB values of the plurality of first pixels and the color coordinate conversion matrix;
determining linear RGB values of the plurality of second pixels according to the initial RGB values of the plurality of second pixels and the gamma value; and
determining the second color coordinates of the plurality of second pixels according to the linear RGB values of the plurality of second pixels and the color coordinate conversion matrix.

In some embodiments, the determining the residual image compensation parameter according to the reference RGB value and the initial RGB value of each of the second pixels includes:
determining a compensation coefficient of each of the second pixels according to a proportional relationship between the initial RGB value of each of the second pixels and the reference RGB value;
wherein the residual image compensation parameter includes the compensation coefficient of each of the second pixels.

In a second aspect, embodiments of the present disclosure provide a residual image compensation apparatus, including:
an acquisition module configured to obtain a target image, wherein the target image is a current frame image for being displayed on a display panel;
a first detection module configured to, when a visual content of the target image is displayed on the display panel for a duration that does not exceed a preset duration, determine whether there is a residual image on the display panel;
a second detection module configured to, in the case that there is a residual image on the display panel, determine a residual image area of the display panel, and determine a residual image compensation parameter according to a display property of the display panel and image information displayed in the residual image area; and
a compensation module configured to, perform, according to the residual image compensation parameter, residual image compensation on a next frame image to be displayed.

In a third aspect, embodiments of the present disclosure provide another residual image compensation apparatus including: a processor, and a memory storing computer program instructions; wherein the processor is configured to read and execute the computer program instructions to implement the residual image compensation method of the first aspect.

In a fourth aspect, embodiments of the present disclosure provide a display device including the residual image compensation apparatus according to the second or third aspect and a display panel.

In some embodiments, the display panel includes a Micro-LED array substrate, and one or more integrated circuits connected to the Micro-LED array substrate.

In a fifth aspect, embodiments of the present disclosure provide a computer-readable storage medium storing therein computer program instructions which, when executed by a processor, implement the residual image compensation method according to the first aspect.

### BRIEF DESCRIPTION OF THE DRAWINGS

The accompanying drawings, which are included to provide a further understanding of the disclosure and are incorporated in and constitute a part of this specification, illustrate embodiment of the disclosure and together with the description serve to explain the present disclosure but do not to limit it. In the drawings:

FIG. 1 is a schematic diagram showing brightness loss of MLEDs of different colors in a MLED display panel;

FIG. 2 is a schematic flowchart of a residual image compensation method according to an embodiment of the present disclosure;

FIG. 3 is a schematic flowchart of another residual image compensation method according to an embodiment of the present disclosure;

FIG. 4 is a schematic flowchart of yet another residual image compensation method according to an embodiment of the present disclosure;

FIG. 5 is a schematic diagram showing the positional relationship between a display panel and an image acquisition apparatus according to an embodiment of the present disclosure;

FIG. 6 is a schematic diagram of an image connection region;

FIG. 7 is a flowchart of an optional implementation of step S3 according to an embodiment of the present disclosure;

FIG. 8 is a schematic flowchart of another residual image compensation method according to an embodiment of the present disclosure;

FIG. 9 is a schematic diagram of a residual image compensation apparatus according to some embodiments of the present disclosure;

FIG. 10 is a schematic diagram of a residual image compensation apparatus according to some embodiments of the present disclosure;

FIG. 11 is a schematic diagram of a computer-readable storage medium according to some embodiments of the present disclosure.

### DETAILED DESCRIPTION

Reference will now be made in detail to the embodiments of the present disclosure, examples of which are illustrated in the accompanying drawings. It should be understood that the particular embodiments described herein are illustrative and explanatory only and are not restrictive of the disclosure.

In order that the objects, technical solutions and advantages of the embodiments of the present disclosure will become more apparent, a more particular description of the embodiments of the present disclosure will be rendered by reference to the appended drawings. It is to be understood that the described embodiments are part, but not all, of the disclosed embodiments. According to the embodiments described in the present disclosure, all other embodiments obtained by a person of ordinary skill in the art without inventive effort fall within the scope of the present disclosure.

Unless defined otherwise, technical or scientific terms used in the examples of the present disclosure shall have the ordinary meaning as understood by one of ordinary skill in the art to which the present disclosure belongs. The terms “first”, “second”, and the like as use herein do not denote any order, quantity, or importance, but rather are used to distinguish one element from another. Similarly, the word “including” or “includes”, and the like, means that the elements or items preceding the word encompass the elements or items listed after the word and equivalents thereof, but do not exclude other elements or items. The terms “connecting” or “connected” and the like are not limited to physical or mechanical connections, but may include electrical connections, whether direct or indirect. The terms “upper”, “lower”, “left”, “right” and the like are used only to indicate relative positional relationships that may change accordingly when the absolute position of the object being described changes.

Mini-LEDs/Micro-LEDs have the advantages of high brightness, high contrast, fast response and low power consumption, so the display technology based on MLED has been widely used in the display field. In particular, high-density MLED arrays may be integrated on a substrate to achieve thin filming, miniaturization, and matrix organization of the MLED display panel.

As compared with a conventional display panel such as a liquid crystal display panel, the MLED display panel has a smaller chip size and a narrower pixel pitch, which results in a higher thermal density. Therefore, the MLED display panel has greater demands for heat dissipation. To meet these technical requirements, the Chip on Glass (COG) technology can be used to implement the display driving of the MLED display panel. Specifically, this is done by directly mounting a MLED chip onto a glass substrate and using Thin Film Transistor (TFT) technology to drive the MLED chips to emit light.

The COG technology is based on glass substrate technology, and uses semiconductor, photolithography and advanced copper technology, to achieve ultra-fine thin film transistor drive structures over large areas. However, since the MLED display panel using the COG integrates high-density Micro-LEDs and Thin Film Transistors (TFTs) with pixel spacing less than 100 μm, it becomes impractical to form additional circuits for temperature measurement and other functions. As a result, it's challenging to perform real-time temperature monitoring to obtain feedback on the display panel's temperature.

However, when a certain image is displayed for a long time on the MLED display panel using the GOG, the TFT drives the MLED to remain illuminated for a long time, so that the temperature of the display panel increases, and the luminous efficiency of the MLED decreases as the temperature increases. Notably, different colors of the MLEDs experience varying degrees of brightness loss with temperature increases. FIG. 1 illustrates the brightness loss of different colored MLEDs in an MLED display panel. As shown in FIG. 1, red MLEDs suffer the most significant brightness loss as the temperature increases. At the same time, it's difficult to obtain temperature feedback from the MLED display panel and thereby effectively compensate for the brightness loss caused by the temperature increase. This leads to the issue of residual image, where the content of a previous image remains visible when the display panel switches to the next image, thus adversely affecting the display quality of the display panel.

In order to solve at least one of the above technical problems, embodiments of the present disclosure provide a residual image compensation method for detecting an area where a residual image appears in a display panel during the display process and compensating the area to improve the display quality of the display panel.

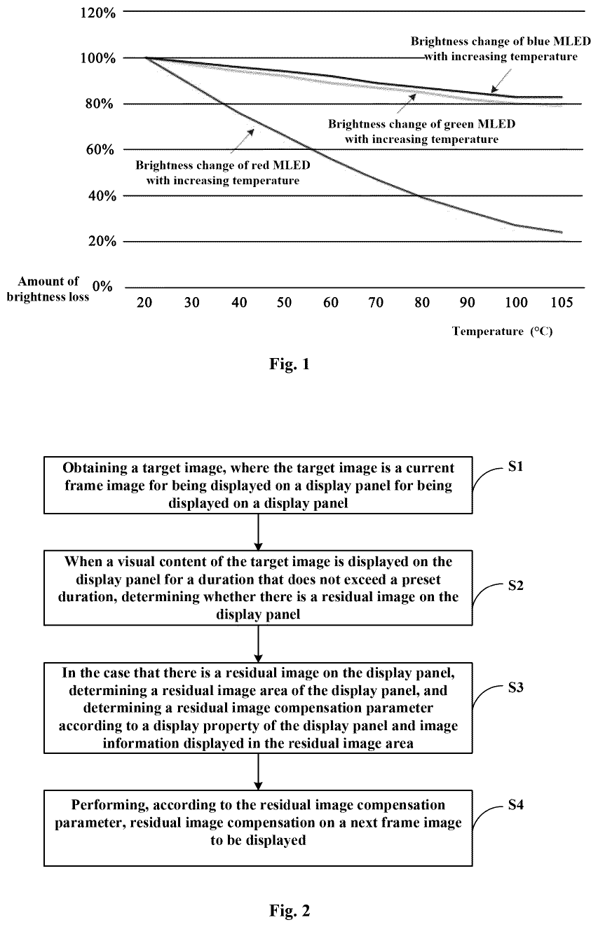

FIG. 2 is a schematic flowchart of a residual image compensation method according to an embodiment of the present disclosure. As shown in FIG. 2, the residual image compensation method includes a plurality of display periods, wherein each display period can display a frame of image, and the following steps S1-S4 are performed at each display period.

Step S1: obtaining a target image, wherein the target image is a current frame image for being displayed on a display panel. The display panel may in particular be a MLED display panel.

The target image is a source image previously obtained from a video source. In the residual image compensation process, when each frame image in the video source is displayed on the display panel, it is subjected to the residual image compensation processing as a target image.

It should be noted that the residual image results from the increase in temperature of the display panel and is not a defect of the image itself. Therefore, the target image, as a source image from the video source, does not have any image defect.

Step S2: when a visual content of the target image is displayed on the display panel for a duration that does not exceed a preset duration, determining whether there is a residual image on the display panel.

Since the residual image on the display panel is generated due to an increase in the temperature of the panel, after a sufficiently long period of time, the display panel cools down adequately, and the residual image disappears. That is to say, the residual image compensation process (i.e., the subsequent steps S3-S4) in the embodiment of the present disclosure is performed when the duration for displaying the visual content of the target image on the display panel does not exceed the preset duration.

For example, the above-mentioned preset duration may be 1 s, 10 s, 30 s, or 1 min, etc., and may be flexibly set according to the property of the display panel, and the embodiments of the present disclosure are not limited thereto.

Step S3: in the case that there is a residual image on the display panel, determining a residual image area of the display panel, and determining a residual image compensation parameter according to a display property of the display panel and image information displayed in the residual image area.

The residual image area of the display panel refers to all the areas on the display panel where the residual image appears, which can either be a single connected closed-loop area or multiple unconnected areas, and the present disclosure is not limited thereto.

Step S4: performing, according to the residual image compensation parameter, residual image compensation on a next frame image to be displayed.

The next frame image to be displayed is also a source image in a video source, and according to a frame sequence preset by the video source, the next frame image of the target image is the next frame image to be displayed on the display panel.

A residual image compensation method according to an embodiment of the present disclosure includes a plurality of display periods, and the above-mentioned steps S1-S4 are performed in one display period. That is, in the display process of the display panel, the above-mentioned processing needs to be performed on each frame of the target image so as to detect in real time whether a residual image appears on the display panel and compensate for the next frame of the image.

Embodiments of the present disclosure provide a residual image compensation method for reducing a residual image appearing on a display panel, wherein the display panel includes a plurality of display periods, and residual image detection and compensation are performed for each display period. Specifically, a residual image detection is performed on a current frame image, that is, a target image, displayed on a display panel, a residual image area and a residual image compensation parameter of the display panel are determined, and the residual image compensation parameter is applied to a next frame image to be displayed, and the residual image compensation is performed thereon, so as to ensure the uniformity of the subsequent display image of the display panel. The above-mentioned residual image compensation parameter is continuously updated during the display process of the display panel, until residual image no longer appears after the display panel is compensated by the residual image compensation parameter which is updated multiple times, so as to improve the display quality of the display panel.

In some embodiments, the next frame image is no longer compensated when the duration for displaying the visual content of the target image on the display panel is more than a preset duration.

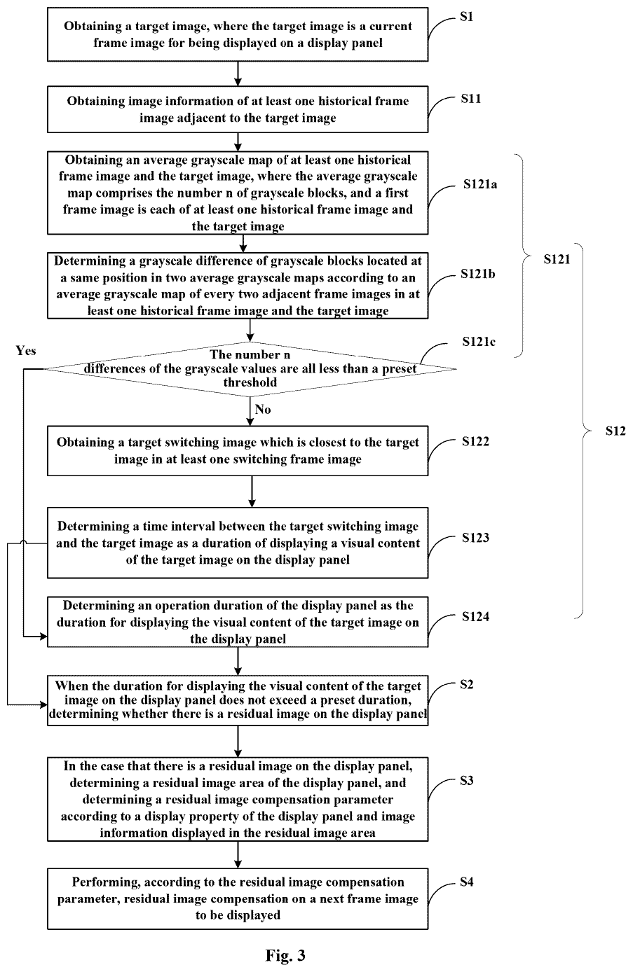

FIG. 3 is a schematic flowchart of another residual image compensation method according to an embodiment of the present disclosure. In some embodiments, as shown in FIG. 3, the residual image compensation method includes the above-described steps S1-S4, and may further include performing steps S11-S12 before determining whether the display panel has the residual image in step S2.

Step S11: obtaining image information of at least one historical frame image adjacent to the target image.

The at least one historical frame image adjacent to the target image refers to the target image corresponding to at least one display period before the current display period.

Step S12: determining, according to the image information of the X historical image frames, the duration for displaying the visual content of the target image on the display panel, that is, the time interval between the visual content of the target image and the previous frame switching image, wherein the switching image is an image where the visual content change occurs between the visual content of the target image and the previous frame image, and X is an integer greater than or equal to 1.

It should be noted that, since the residual image compensation in the embodiments of the present disclosure is performed when the duration for displaying the visual content of the target image on the display panel does not exceed the preset duration, the number of frames X can be set as the number of image frames displayed by the display panel at the preset duration. For example, if the display panel can display 60 image frames for a preset duration, it is detected whether there is a switching image in the 60 image frames before the target image. If it is, determining the duration for displaying the visual content of the target image on the display panel according to the time interval between the switching image and the target image; if otherwise, it indicates that the duration for displaying the visual content of the target image on the display panel has exceeded the preset duration, and the next frame image is no longer compensated.

In addition, the number of frames X may also have no relationship with the number of image frames displayed by the display panel at a preset duration, which may be 10 image frames, 30 image frames, 120 image frames, etc. and the number of historical image frames is not limited in the embodiments of the present disclosure.

In some embodiments, step S12 may include steps S121-S124:

Step S121: determining, according to the at least one historical frame image and the target image, whether there is a switching image. If it is, step S122 is performed, if otherwise, step S124 is performed.

In some embodiments, the determining whether there is the switching image in step S121 may specifically include steps S121a-S121c.

Step S121a: obtaining an average grayscale map of the at least one historical frame image and the target image, wherein the average grayscale map includes the number n of grayscale blocks, wherein the number n is a positive integer greater than 1.

Each grayscale block may be an image block with a uniform grayscale, and each grayscale block may include a plurality of pixels.

Specifically, at least one historical frame image and the target image may both be RGB images, and step S121a may include: for each frame image of at least one historical frame image and the target image, performing the followings steps.

First, the image is converted into a grayscale map. Thereafter, the grayscale map is divided into the number m*m of first regions, each of the first regions includes a plurality of pixels, wherein the number m is an integer greater than 1, and the number n is equal to the number m*m. It determines a grayscale value of each of the first regions according to the grayscale values of a plurality of pixels in each of the first regions, wherein the grayscale value of the first region is an average value of the grayscale values of the plurality of pixels. Finally, an average grayscale map including the number n of grayscale blocks is generated from the grayscale value of each of the first regions.

For example, the resolution of any one of at least one historical frame image and the target image is 256*256 bpi, which is converted into a grayscale map, and the grayscale map is divided into 64*64 first regions, and thus 4*4 pixels are included in each first region. It calculates an average value of the grayscale values of 16 pixels in each of the first regions, and assigns the average value to the first region to form a grayscale block, and finally generates an average grayscale map including 64*64 grayscale blocks.

Step S121b: determining a grayscale difference of grayscale blocks located at a same position in two average grayscale maps according to an average grayscale map of every two adjacent frame images in at least one historical frame image and the target image.

Step S121c: in the case that each of the number n of differences of the grayscale values is less than a preset threshold, determining that there is no switching image, and performing step S124; otherwise, determining that the latter frame in the two adjacent frame images is a switching image, and performing step S122.

It should be understood that the grayscale difference of grayscale blocks located at the same position in the average grayscale map of two adjacent frame images represents the image difference of the two adjacent frame images at the same position; therefore, when each of the differences of the grayscale values is less than a preset threshold, it is determined that there is no obvious difference between the two adjacent frame images, that is, there is no switching image.

Step S122: obtaining a target switching image which is closest to the target image in the at least one switching frame image.

It should be understood that a plurality of visual content switching may occur in at least one historical frame image and the target image, i.e., there are a plurality of frame switching images; in this case, the switching image with the minimum number of frame intervals with respect to the target image is the target switching image. In at least one historical frame image and the target image, the target switching image and the subsequent image are consistent with the visual content of the target image.

Step S123: determining a time interval between the target switching image and the target image as the duration for displaying the visual content of the target image on the display panel.

Step S124: determining an operation duration of the display panel as the duration for displaying the visual content of the target image on the display panel.

In other embodiments, the above step S12 may specifically include:
during the operation of the display panel, performing image detection on each current frame image/target image and the previous frame image, and determining an average grayscale map of two adjacent frame images; and determining whether the target image is a switching image based on the two average grayscale maps; starting from the display of the first frame image on the display panel, a counter is used to count the number of frames displayed. The counted number of frames multiplied by the display duration of each frame image is used to represent the display duration of the current frame image's screen content on the display panel. Each time a switching image is detected, the counter is reset to zero, and the display duration of the screen content after the switch on the display panel is recalculated.

The above-mentioned display duration of each frame image is determined according to the display property of the display panel, and the embodiments of the present disclosure do not elaborate further on this aspect.

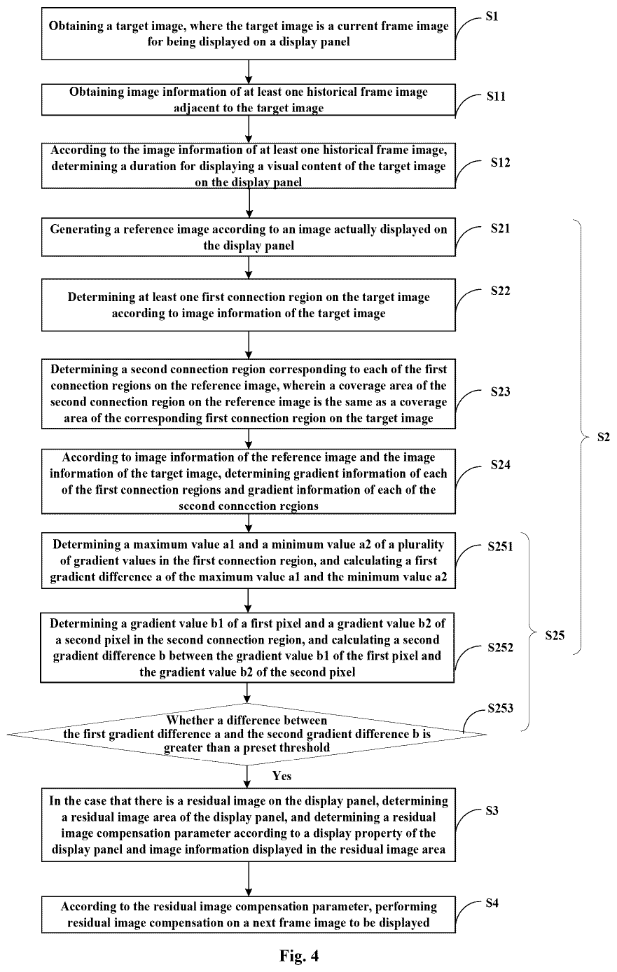

FIG. 4 is a schematic flowchart of another residual image compensation method according to an embodiment of the present disclosure. As shown in FIG. 4, the residual image compensation method includes the above-mentioned steps S1, S11, S12 and S2-S4 which are executed in each display period, wherein in the residual image compensation method shown in FIG. 4, the step S2 of determining whether there is a residual image on the display panel may specifically include:
step S21: generating a reference image according to an image actually displayed on the display panel.

In some embodiments, step S21 may specifically include:
photographing the display panel to obtain an initial photographed image; and performing distortion correction on the initial photographed image to obtain the reference image.

The purpose of distortion correction is to make the resolution of the reference image and the target image obtained by photographing consistent, so as to facilitate detection and analysis on the reference image and the target image, judge whether there is a residual image on the display panel, and determine a residual image area.

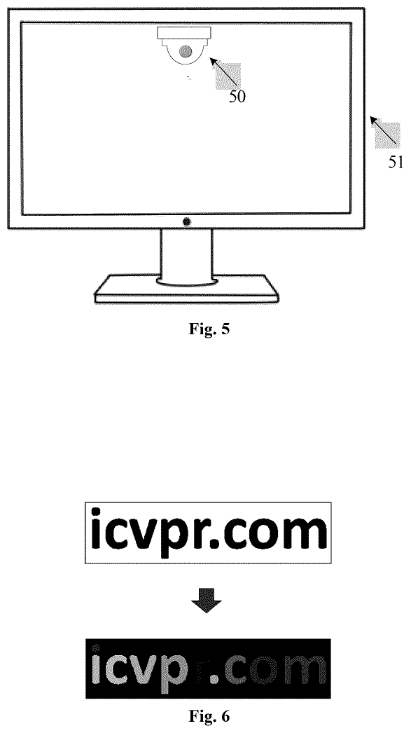

FIG. 5 is a schematic diagram showing the positional relationship between a display panel and an image acquisition apparatus according to an embodiment of the present disclosure. For example, as shown in FIG. 5, an image acquisition apparatus 50 fixed to a first edge of a display panel 51 and communicatively connected to the display panel may photograph the display panel to obtain an initial photographed image. The first edge refers to an upper edge of the display panel 51 in a vertically placed state, and the above-mentioned image acquisition apparatus 50 may be fixed at another position on the display panel 51 or may not be fixed on the display panel 51. The image acquisition apparatus 50 may be a camera, and may also be another terminal device having a photographing function and a communication function, such as a mobile phone and a tablet computer, and the embodiments of the present disclosure are not limited thereto.

Step S22: determining at least one first connection region on the target image according to the image information of the target image.

It should be noted that the connection region refers to a minimum region in an image where no color change occurs. The residual image on the display panel refers to a region that is supposed to display the same color (i.e., within the same connection region) but exhibit color differences, leading to shaped residual image distinguishable by the human eye. Therefore, segmenting out at least one connection domain in the image is an important step in detecting and compensating for the residual image on the display panel.

FIG. 6 is a schematic diagram of image connection regions. For example, as shown in FIG. 6, the letter “i” includes two connection regions and the letter “c” includes one connection region. The above-mentioned specific algorithms for determining at least one connection region may be a region growing method and a seed filling method, and may also be an example segmentation algorithm based on depth learning, such as Mask RNN, and the embodiments of the present disclosure are not limited thereto.

Step S23: determining a second connection region corresponding to each of the first connection regions on the reference image, wherein a coverage area of the second connection region on the reference image is the same as a coverage area of the corresponding first connection region on the target image.

It should be understood that the reference image is obtained by photographing the visual content on the display panel, and during the shooting process, reflections may occur on the display panel, or there may be a residual image, etc., which lead to the connection region obtained by directly performing connection region detection on the reference image through a preset algorithm is inaccurate. Thus, it is assumed by default that the coverage area of the second connection region on the reference image is the same as the coverage area of the corresponding first connection region on the target image.

Step S24: determining, according to the image information of the reference image and image information of the target image, gradient information of each of the first connection regions and gradient information of each of the second connection regions. The gradient information of the first connection region includes a gradient value of each pixel in the first connection region, and the gradient information of the second connection region includes a gradient value of each pixel in the second connection region.

For example, step S24 may include: performing high-pass filtering on the target image so as to obtain the first connection region information and perform denoising on the target image to obtain a filtered map; performing gradient filtering on the filtered map to enhance the image contrast so as to obtain a gradient map of the target image; traversing at least one first connection region on the gradient map, and for each first connection region, obtaining a first gradient value for each pixel in the first connection region. Based on the same method, the reference image is processed to obtain a second gradient value for each pixel in the second connection region.

Step S25: determining, according to the gradient information of each of the first connection regions and the gradient information of each of the second connection regions, whether there is a residual image in an area corresponding to each of the second connection regions on the display panel.

In some embodiments, step S25 may specifically include: for each of the second connection regions and its corresponding first connection region, the following steps S251 to S253 are performed.

Step S251: determining a maximum value a1 and a minimum value a2 of a plurality of gradient values in the first connection region, and calculating a first gradient difference a between the maximum value a1 and the minimum value a2.

Step S252: determining a gradient value b1 of a first pixel and a gradient value b2 of a second pixel in the second connection region, and calculating a second gradient difference b between the gradient value b1 of the first pixel and the gradient value b2 of the second pixel; wherein the first pixel is a pixel at the same position as the pixel with the maximum gradient value in the first connection region, and the second pixel is a pixel at the same position as the pixel with the minimum gradient value in the first connection region.

Step S253: determining whether the difference between the first gradient difference a and the second gradient difference b is greater than a preset threshold, and if it is, determining that a residual image exists in a corresponding region on the display panel in the second connection region.

It should be understood that, since the reference image is obtained by photographing the display panel, the residual image appearing on the panel can affect the uniformity of the reference image. Moreover, since the target image comes from a video source and its screen content within the same connection region is uniform, identifying the connection region where there is a significant difference in gradient between the reference image and the target image helps to determine an area of non-uniformity on the reference image. The area of non-uniformity correspond to a location where the residual image appears on the display panel.

In the residual image compensation method shown in FIG. 4, determining the residual image area of the display panel in step S3 may specifically include: determining a coverage area of all second connection regions corresponding to the residual image as the residual image area.

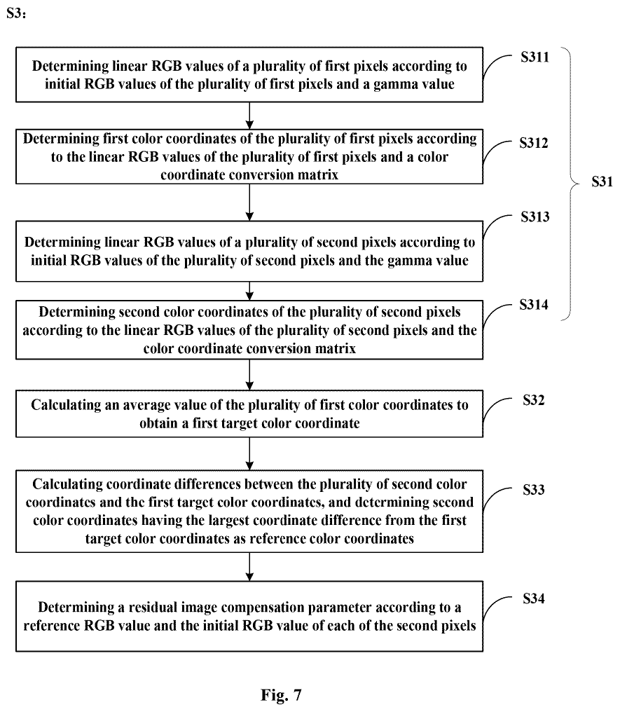

FIG. 7 is a flowchart of an alternative implementation method of step S3 according to an embodiment of the present disclosure. In some embodiments, the residual image area includes at least one sub-area, and each sub-area corresponds to a second connection region, respectively. As shown in FIG. 7, in step S3, the residual image compensation parameter is determined according to the display property of the display panel and the image information of the image displayed in the residual image area, which may specifically include: for each sub-area, the following steps S31 to S34 are performed.

Step S31: obtaining first color coordinates of a plurality of first pixels of the target image in the sub-area and second color coordinates of a plurality of second pixels of the reference image in the sub-area according to the display property of the display panel.

In some embodiments, the display property of the display panel include at least a gamma value and a color coordinate conversion matrix of the display panel; step S31 may specifically include the following steps.

Step S311: determining a linear RGB value of the plurality of first pixels according to initial RGB values of the plurality of first pixels and the gamma value.

For example, the linear RGB value for each of the first pixels described above can be calculated by the following formula 1:

$${R}_{linear} = {R}_{input}^{\frac{1}{γ}} , {G}_{linear} = {G}_{input}^{\frac{1}{γ}} , {B}_{linear} = {B}_{input}^{\frac{1}{γ}} , \qquad Formula 1$$

wherein Rᵢₙₚᵤₜ, Gᵢₙₚᵤₜ, Bᵢₙₚᵤₜ represent an initial RGB value of the first pixel, y represents a gamma value of the display panel, and Rₗᵢₙₑₐᵣ, Gₗᵢₙₑₐᵣ, Bₗᵢₙₑₐᵣ represent a linear RGB value of the first pixel.

Step S312: determining first color coordinates of the plurality of first pixels according to the linear RGB values of the plurality of first pixels and the color coordinate conversion matrix.

In the same example as step S311, the first color coordinate of each of the first pixels above-mentioned can be calculated by Formula 2 and Formula 3, specifically as follows:

$$[ \begin{matrix}X \\ Y \\ Z\end{matrix} ] = [ \begin{matrix}{x}_{r} & {x}_{g} & {x}_{b} \\ {y}_{r} & {y}_{g} & {y}_{b} \\ {z}_{r} & {z}_{g} & {z}_{b}\end{matrix} ] [ \begin{matrix}{R}_{linear} \\ {G}_{linear} \\ {B}_{linear}\end{matrix} ] \qquad Formula 2$$

$${x}_{1} = \frac{X}{X + Y + Z} , {y}_{1} = \frac{Y}{X + Y + Z} \qquad Formula 3$$

wherein

$$[ \begin{matrix}{x}_{r} & {x}_{g} & {x}_{b} \\ {y}_{r} & {y}_{g} & {y}_{b} \\ {z}_{r} & {z}_{g} & {z}_{b}\end{matrix} ]$$

represents a color coordinate conversion matrix, and (x₁, y₁) represents a first color coordinate.

Step S313: determining linear RGB values of the plurality of second pixels according to the initial RGB values of the plurality of second pixels and the gamma value.

Step S314: determining the second color coordinates of the plurality of second pixels according to the linear RGB values of the plurality of second pixels and the color coordinate conversion matrix.

The specific calculation process of the above-mentioned step S313 and step S311 are the same, that is, the linear RGB values of a plurality of second pixels can be determined through Formula 1, and the specific calculation process of step S314 and step S312 are the same, that is, the second color coordinates of the second pixels can be determined through Formula 2 and Formula 3, and each second color coordinate can be expressed as (xᵢ, yᵢ).

Step S32: calculating an average value of the plurality of first color coordinates to obtain first target color coordinates.

It should be understood that the determination of the residual image compensation parameter is for each sub-area on the display panel, and that each sub-area on the display panel corresponds to the first connection region of the target image and the second connection region on the reference image. Thus, determining the first color coordinates of the plurality of first pixels in each sub-area is equivalent to determining the first color coordinates of the plurality of first pixels in the first connection region. Since the target image is a uniform image, ideally, the color coordinates of the first pixels located in the same first connection region are the same. In consideration of the image error, an average value of the plurality of first color coordinates is determined as a color coordinate of the entire first connection region, i.e., a first target color coordinate. In the same example as step S311, the first target color coordinate may be expressed as (xᵢₙₚᵤₜ, yᵢₙₚᵤₜ).

Step S33: calculating coordinate differences between the plurality of second color coordinates and the first target color coordinates, and determining second color coordinates having the largest coordinate difference from the first target color coordinate as reference color coordinates.

Since the initial RGB value of the second pixel corresponding to the highest display panel temperature is already at the maximum value, it is no longer possible to continuously increase the RGB value to change the second color coordinate. Therefore, it is necessary to take the color coordinate of the pixel having the largest difference from the first target color coordinate as the reference color coordinate, and adjust the RGB value of the other second pixel so that the adjusted second color coordinate coincides with the reference color coordinate.

For example, the reference color coordinates can be calculated by Formula 4 as follows:

$$[ \begin{matrix}{x}_{target} \\ {y}_{target}\end{matrix} ] = [ \begin{matrix}{x}_{i} \\ {y}_{i}\end{matrix} ] s . t . max ( \sqrt[2]{{( {x}_{i} - {x}_{input} )}^{2} + {( {y}_{i} - {y}_{input} )}^{2}} ) , \qquad Formula 4$$

wherein (x_{target}, y_{target}) represents a reference color coordinate, and (xᵢ, yᵢ) represents any one of a plurality of second color coordinates.

Step S34: determining a residual image compensation parameter according to a reference RGB value and an initial RGB value of each of the second pixels, wherein the reference RGB value is the initial RGB value of the second pixel corresponding to the reference color coordinate, which can be expressed as (R_{target}, G_{target}, B_{target}).

In some embodiments, step S34 may specifically include:
determining a compensation coefficient of each of the second pixels according to a proportional relationship between the initial RGB value of each of the second pixels and the reference RGB value; wherein the residual image compensation parameter includes the compensation coefficient of each of the second pixels.

In the same example as step S311, the compensation coefficient of each of the second pixels can be calculated by Formula 5, specifically as follows:

$${k}_{R}^{i} = \frac{{R}_{target}}{{R}_{i}} , {k}_{G}^{i} = \frac{{G}_{target}}{{G}_{i}} , {k}_{B}^{i} = \frac{{B}_{target}}{{B}_{i}} , \qquad Formula 5$$

wherein

$$( {k}_{R}^{i} , {k}_{G}^{i} , {k}_{B}^{i} )$$

represents a compensation coefficient of each of the second pixels, and (Rᵢ, Gᵢ, Bᵢ) is an initial RGB value of each of the second pixels.

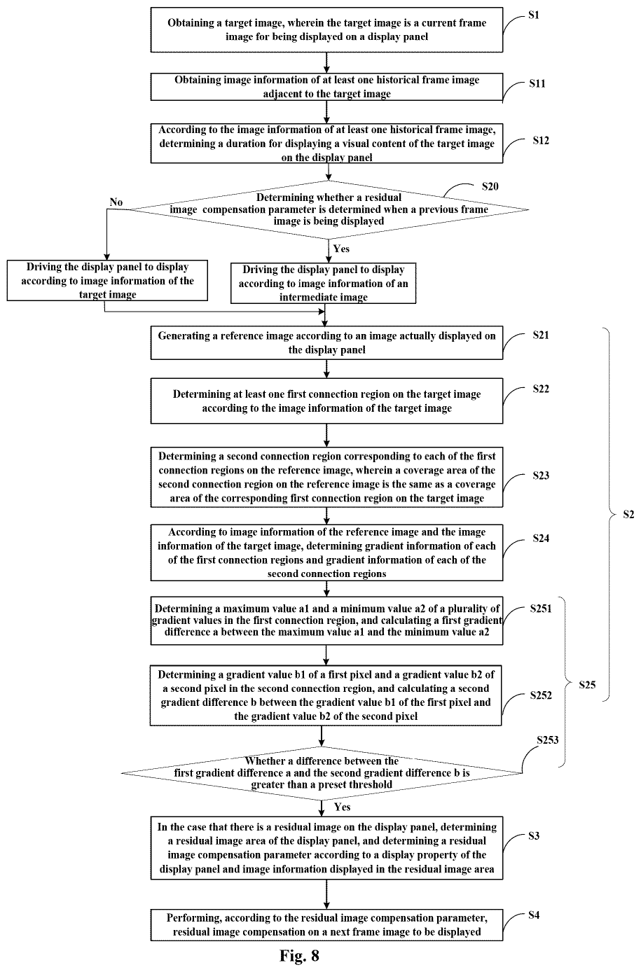

FIG. 8 is a schematic flowchart of another residual image compensation method according to an embodiment of the present disclosure. As shown in FIG. 8, the residual image compensation method includes the steps shown in FIG. 4, and in addition, the residual image compensation method shown in FIG. 8 further includes: before step S21,
step S20: determining whether a residual image compensation parameter is determined in a display process of a previous frame image (that is, the previous display period); if it is, driving the display panel to display according to image information of an intermediate image, wherein the intermediate image is an image after performing residual image compensation on the target image according to the residual image compensation parameter determined in the previous display period; if otherwise, driving the display panel to display according to the image information of the target image.

It should be understood that according to steps S1-S4, the residual image compensation method provided by the embodiments of the present disclosure determines a residual image compensation parameter and performs residual image compensation on the next frame image to be displayed in the case that the duration for displaying the visual content of the target image on the display panel does not exceed the preset duration and there is a residual image area on the display panel. That is to say, in the case that the historical residual image compensation parameter is determined in the previous display period, and after the target image is obtained in the current display period, the target image will be compensated according to the historical residual image compensation parameter, that is, the visual content displayed on the display panel is an intermediate image compensated according to the historical residual image compensation parameter, and it is not a source image.

Further, when the image displayed on the display panel is an intermediate image, the reference image is obtained by photographing the intermediate image on the display panel.

In addition, it needs to be clear that a target image and an intermediate image both refer to a current frame image displayed on a display panel, and the difference lies in that the target image is directly obtained from a multi-frame image of a video source, that is, a source image, and the intermediate image refers to an image after residual image compensation is performed on the target image, wherein a parameter applied for a residual image compensation is a historical residual image compensation parameter.

It should also be noted that when the duration for displaying the visual content of the target image on the display panel exceeds a preset duration or there is no residual image area on the display panel, no new residual image compensation parameter is determined in the current display period, and in this case, residual image compensation can be performed on the next frame image to be displayed according to the historical residual image compensation parameter, or the residual image compensation can no longer be performed on the display panel. This can be further explained through the following specific examples.

In some embodiments, the video source to be displayed on the display panel includes the number N of frames images with the same visual content, wherein the number n1 frames of images can be displayed on the display panel within a preset duration (the number N is greater than the number n1, and both the number N and the number n1 are positive integers), and in the process of displaying the above-mentioned video source on the display panel, the residual image compensation is performed for the display panel. The following situations can be specifically included.

Example 1: in a first display period, the display panel receives a first frame image in a video source for display, and at this time, a target image is the first frame image, and there is neither a previous frame image nor a historical residual image compensation parameter determined according to the previous frame images; therefore, the steps in FIG. 2 can be executed to perform residual image compensation on a target image in the next display period.

Example 2: in a second display period, the display panel receives a second frame images from the video source for display, and determines that the second frame images is within a preset display duration. In the case that the residual image of the display panel is not detected in the first display period, the source image of the second frame image is displayed on the display panel in the second display period, then the reference image is obtained through the visual content of the second frame image on the display panel; in the case that the residual image of the display panel is detected in the first display period, it performs residual image compensation on the second frame image according to the residual image compensation parameter determined in the first display period, and an intermediate image obtained after compensating the second frame source image is displayed on the display panel, then the reference image is obtained by photographing the visual content of the intermediate image displayed on the display panel.

Example 3, in a (n1−1)^{th} display period: the display panel receives the (n1−1)^{th} frame image from the video source for display, and determines that the (n1−1)^{th} frame image is within a preset display duration. When determining that there is a residual image on the display panel in the current display period, it updates the residual image compensation parameter as A; when determining that there is no residual image on the display panel in the current display period, the residual image compensation parameter B determined in the historical display period is used; according to the residual image compensation parameter A or B, the n1^{th} frame image is compensated.

Example 4: in a n1^{th} display period: the display panel receives the n1^{th} frame image from the video source for display, and at this time, it is determined that the n1^{th} frame image exceeds the preset display duration, no other processing is performed, and the n1^{th} frame image is directly output. In this display period, since the n1^{th} frame image has been compensated by the residual image compensation parameter A or B in the (n1−1)^{th} display period, an intermediate image obtained after compensating the nit source image is displayed on the display panel, and then the reference image is obtained by photographing the visual content of the intermediate image displayed on the display panel.

Example 5: in a (n1+1)^{th} display period, the display panel receives the (n1+1)^{th} frame of image in the video source for display, and at this time, it determines that the (n1+1)^{th} frame image exceeds the preset display duration. In the display period, since the (n1+1)^{th} frame image is not compensated by the residual image compensation parameter, the (n1+1)^{th} source image is displayed on the display panel, and then the reference image is obtained according to the visual content of the (n1+1)^{th} source image displayed on the display panel.

In conjunction with the above example, in the case that the current frame image displayed on the display panel, that is, the target image, is neither compensated by the residual image compensation parameter in the previous display period, nor exceeds the preset display duration, the reference image is obtained according to the target image; otherwise, the reference image is obtained according to the intermediate image.

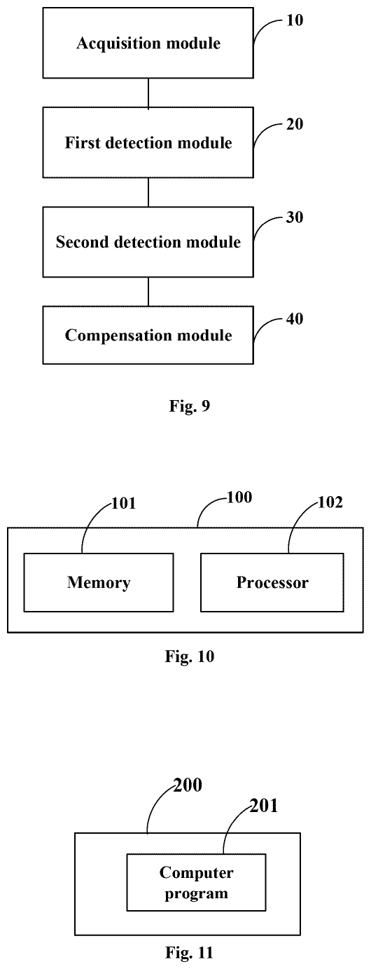

FIG. 9 is a schematic diagram of a residual image compensation apparatus for performing the above residual image compensation method. As shown in FIG. 9, the residual image compensation apparatus includes: an acquisition module 10, a first detection module 20, a second detection module 30 and a compensation module 40.

The acquisition module 10 is configured to obtain a target image at each display period, wherein the target image is a current frame image for display on the display panel.

The first detection module 20 is configured to determine whether there is a residual image on the display panel when the duration for displaying the visual content of the target image on the display panel does not exceed the preset duration.

The second detection module 30 is configured to determine a residual image area of the display panel in the presence of a residual image on the display panel, and determine a residual image compensation parameter according to a display property of the display panel and image information of an image displayed in the residual image area.

The compensation module 40 is configured to perform residual image compensation on the next frame image to be displayed according to the residual image compensation parameter.

The function of each module is described in the above-mentioned residual image compensation method, and will not be described again herein.

FIG. 10 is a schematic diagram of a residual image compensation apparatus according to some embodiments of the present disclosure. As shown in FIG. 10, the residual image compensation apparatus 100 includes: a memory 101 and a processor 102, the memory 101 stores therein a computer program, wherein the processor 102 is used to execute the computer program to implement the residual image compensation method described above, for example, implementing steps S1 to S4 in FIG. 2.

The residual image compensation apparatus 100 may be a computing device such as a desktop computer, a notebook computer, a palmtop computer, and a cloud server. The residual image compensation apparatus 100 may include, but is not limited to, a processor 102 and a memory 101. It will be understood by those skilled in the art that FIG. 10 is merely an example of the residual image compensation apparatus 100, and does not constitute a limitation on the residual image compensation apparatus 100, and may include more or less components than those illustrated, or combine some components, or different components, for example, the residual image compensation apparatus 100 may further include an input device, an output device, a network access device, a bus, etc.

The processor 102 may be a Central Processing Unit (CPU) or other general purpose processor, a Digital Signal Processor (DSP), an Application Specific Integrated Circuit (ASIC), a Field-Programmable Gate Array (FPGA) or other programmable logic device, a discrete gate or transistor logic device, a discrete hardware component, etc. The general-purpose processor 102 may be a microprocessor or the processor may be any conventional processor or the like.

The memory 101 may be an internal storage unit of the residual image compensation apparatus 100, such as a hard disk or a storage of the residual image compensation apparatus 100. The memory 101 may also be an external storage device of the residual image compensation apparatus 100, such as a plug-in hard disk, a Smart Media Card (SMC), a Secure Digital (SD) card, a flash Card provided on the residual image compensation apparatus 100. Further, the memory 101 may include both an internal storage unit and an external storage device of the residual image compensation apparatus 100. The memory 101 is used to store the computer program and other programs and data required by the terminal device. Memory 101 may also be used to temporarily store data that has been output or is to be output.

It can be clearly understood by a person skilled in the art that, for the convenience and brevity of description, the above-mentioned division of various functional units and modules is merely exemplified, and in practical applications, the above-mentioned function allocation can be implement by different functional units and modules according to needs, that is, the internal structure of the apparatus may be divided into different functional units or modules so as to complete all or part of the functions described above. Each functional unit and module in the embodiments may be integrated in one processing unit, or each unit may physically exist separately, or two or more units may be integrated in one unit, and the above-mentioned integrated units may be implemented in the form of hardware or software functional units. In addition, the specific names of various functional units and modules are merely for facilitating mutual distinction, and are not used to limit the protection scope of the present application. The specific working processes of the units and modules in the above-mentioned system can be referred to the corresponding processes in the above-mentioned method embodiments and will not be described in detail herein.

Embodiments of the present disclosure also provide a display device including the residual image compensation apparatus and the display panel of FIG. 9 or FIG. 10 described above. The display panel display panel may be a MLED display panel, which includes a Micro-LED array substrate, and one or more integrated circuits connected to the Micro-LED array substrate.

FIG. 11 is a schematic diagram of a computer-readable storage medium according to some embodiments of the present disclosure. As shown in FIG. 11, a computer-readable storage medium 200 stores therein the computer program 201, wherein the computer program 201, when executed by a processor, implements the residual image compensation method, e.g., implementing steps S1 to S4 in FIG. 2. The computer-readable storage medium 200 includes, but is not limited to, RAM, ROM, EEPROM, flash memory or other memory technology, CD-ROM, Digital Versatile Disk (DVD) or other optical disk storage, magnetic cassette, magnetic tape, magnetic disk storage or other magnetic storage device, or any other medium which can be used to store the desired information and which can be accessed by a computer. Moreover, as known by those of ordinary skill in the art, the communication medium typically includes computer readable instructions, data structures, program modules or other data in a modulated data signal such as a carrier or other transport mechanism, and may include any information delivery media.

It is to be understood that the above-described embodiments are merely exemplary embodiments that have been employed to illustrate the principles of the present disclosure, and the present disclosure is not limited thereto. It will be apparent to those skilled in the art that various modifications and variations can be made in the present disclosure without departing from the spirit or scope of the present disclosure.

1. A residual image compensation method, comprising:
obtaining a target image, wherein the target image is a current frame image for being displayed on a display panel;
when a visual content of the target image is displayed on the display panel for a duration that does not exceed a preset duration, determining whether there is a residual image on the display panel;
in the case that there is the residual image on the display panel, determining a residual image area of the display panel, and determining a residual image compensation parameter according to a display property of the display panel and image information of an image displayed in the residual image area;
performing, according to the residual image compensation parameter, residual image compensation on a next frame image to be displayed.

2. The method according to claim 1, wherein before determining whether there is the residual image on the display panel, the method further comprises:
obtaining image information of at least one historical frame image adjacent to the target image;
determining, according to the image information of the at least one historical frame image, the duration for displaying the visual content of the target image on the display panel.

3. The method according to claim 2, wherein the determining, according to the image information of the at least one historical frame image, the duration for displaying the visual content of the target image on the display panel comprises:
comparing the at least one historical frame image and the target image, to determine whether there is a switching image, wherein a change in visual content occurs between the switching image and a frame image previous to the switching image;
when there is at least one switching frame image, obtaining a target switching image which is closest to the target image in at least one switching frame image;
determining a time interval between the target switching image and the target image as the duration for displaying the visual content of the target image on the display panel.

4. The method according to claim 3, wherein the comparing the at least one historical frame image and the target image to determine whether there is the switching image comprises:
obtaining an average grayscale map of the at least one historical frame image and the target image, wherein the average grayscale map comprises number n of grayscale blocks, wherein the number n is a positive integer greater than 1;
with respect to an average grayscale map of every two adjacent frame images in at least one historical frame image and the target image, determining a grayscale difference of grayscale blocks located at a same position in two average grayscale maps;
in the case that each of number n of grayscale differences is less than a preset threshold, determining that there is no switching image; otherwise, determining that a next one in the two adjacent frame images is a switching image.

5. The method according to claim 4, wherein the obtaining the average grayscale map of the at least one historical frame image and the target image comprises:
with respect to the at least one historical frame image and each frame image of the target image, performing the followings:
converting the image into a grayscale map;
dividing the grayscale map into the number m*m of first regions, wherein each of the first regions comprises a plurality of pixels, the number m is an integer greater than 1, and the number n is equal to the number m*m;
determining a grayscale value of each of the first regions according to grayscale values of the plurality of pixels in each of the first regions, wherein the grayscale value of the first region is an average value of the grayscale values of the plurality of pixels;
generating an average grayscale map comprising the number n of grayscale blocks according to the grayscale value of each of the first regions.

6. The method according to claim 1, wherein the determining whether there is the residual image on the display panel comprises:
generating a reference image according to an image actually displayed on the display panel;
determining at least one first connection region on the target image according to the image information of the target image;
determining a respective second connection region corresponding to each of the first connection regions on the reference image, wherein a coverage area of the second connection region on the reference image is same as a coverage area of the corresponding first connection region on the target image;
determining, according to the image information of the reference image and image information of the target image, gradient information of each of the first connection regions and gradient information of each of the second connection regions;
determining, according to the gradient information of each of the first connection regions and the gradient information of each of the second connection regions, whether there is the residual image in an area corresponding to each of the second connection regions on the display panel.

7. The method according to claim 6, wherein the gradient information of the first connection region comprises a gradient value of each pixel in the first connection region, and the gradient information of the second connection region comprises a gradient value of each pixel in the second connection region;
determining, according to the gradient information of each of the first connection regions and the gradient information of each of the second connection regions, whether there is the residual image in the area corresponding to each of the second connection regions on the display panel comprises:
with respect to each of the second connection regions and the first connection region corresponding to the second connection region, performing the followings:
determining a maximum value and a minimum value of a plurality of gradient values in the first connection region, and calculating a first gradient difference between the maximum value and the minimum value;
determining a gradient value of a first pixel and a gradient value of a second pixel in the second connection region; wherein the first pixel is a pixel at a same position as a pixel with the maximum gradient value in the first connection region, and the second pixel is a pixel at a same position as a pixel with the minimum gradient value in the first connection region;
calculating a second gradient difference between the gradient value of the first pixel and the gradient value of the second pixel;
determining whether the difference between the first gradient difference and the second gradient difference is greater than a preset threshold, and if it is, determining that there is the residual image in an area corresponding to the second connection region on the display panel.

8. The method according to claim 6, wherein the determining the residual image area of the display panel comprises:
determining a coverage area of all second connection regions corresponding to the residual image as the residual image area.

9. The method according to claim 6, wherein before generating the reference image according to the image actually displayed on the display panel, the method further comprises:
determining whether a residual image compensation parameter has been determined when a previous frame image is being displayed;
if it is, driving the display panel to display according to image information of an intermediate image, wherein the intermediate image is an image obtained by performing residual image compensation on the target image according to the residual image compensation parameter determined when the previous frame image is being displayed;
if otherwise, driving the display panel to display according to the image information of the target image.

10. The method according to claim 6, wherein the generating the reference image according to the image actually displayed on the display panel comprises:
photographing the display panel to obtain an initial photographed image;
performing distortion correction on the initial photographed image to obtain the reference image.

11. The method according to claim 8, wherein the residual image area comprises at least one sub-area, and each of the at least one sub-area corresponds to a respective one of the second connection regions; and the determining the residual image compensation parameter according to the display property of the display panel and the image information of the image displayed in the residual image area comprises:
with respect to each of the at least one sub-area,
obtaining, according to the display property of the display panel, first color coordinates of a plurality of first pixels of the target image in the sub-area and second color coordinates of a plurality of second pixels of the reference image in the sub-area;
calculating an average value of the plurality of first color coordinates to obtain a first target color coordinate;
calculating coordinate differences between the plurality of second color coordinates and the first target color coordinates, and determining a second color coordinate having a largest coordinate difference with respect to the first target color coordinate as the reference color coordinate;
determining the residual image compensation parameter according to a reference RGB value and an initial RGB value of each of the second pixels, wherein the reference RGB value is an initial RGB value of the second pixel corresponding to the reference color coordinates.

12. The method according to claim 11, wherein the display property of the display panel comprises at least a gamma value and a color coordinate conversion matrix of the display panel;
the obtaining the first color coordinates of the plurality of first pixels of the target image in the residual image area and the second color coordinates of the plurality of second pixels of the reference image in the residual image area according to the display property of the display panel comprises:
determining linear RGB values of the plurality of first pixels according to the initial RGB values of the plurality of first pixels and the gamma value;
determining the first color coordinates of the plurality of first pixels according to the linear RGB values of the plurality of first pixels and the color coordinate conversion matrix;
determining linear RGB values of the plurality of second pixels according to the initial RGB values of the plurality of second pixels and the gamma value;
determining the second color coordinates of the plurality of second pixels according to the linear RGB values of the plurality of second pixels and the color coordinate conversion matrix.

13. The method according to claim 11, wherein the determining the residual image compensation parameter according to the reference RGB value and the initial RGB value of each of the second pixels comprises:
determining a compensation coefficient of each of the second pixels according to a proportional relationship between the initial RGB value of each of the second pixels and the reference RGB value;
wherein the residual image compensation parameter comprises the compensation coefficient of each of the second pixels.

14. (canceled)

15. An residual image compensation apparatus, comprising a processor, and a memory storing therein a computer program instruction; wherein the processor is configured to read and execute the computer program instruction to implement the residual image compensation method according to claim 1.

16. A display device, comprising the display panel and the residual image compensation apparatus according to claim 15.

17. The display device according to claim 16, wherein the display panel comprises a Micro-light Emitting Diode (LED) array substrate, and one or more integrated circuits connected to the Micro-LED array substrate.

18. A computer-readable storage medium storing therein a computer program instruction, wherein the computer program instruction is used to be executed by a processor to implement the residual image compensation method according to any one of claim 1.

19. The residual image compensation apparatus according to claim 15, wherein the processor is further configured to read and execute the computer program instruction to: before determining whether there is the residual image on the display panel,
obtain image information of at least one historical frame image adjacent to the target image;
determine, according to the image information of the at least one historical frame image, the duration for displaying the visual content of the target image on the display panel.

20. The residual image compensation apparatus according to claim 19, wherein the determining, according to the image information of the at least one historical frame image, the duration for displaying the visual content of the target image on the display panel comprises:
comparing the at least one historical frame image and the target image, to determine whether there is a switching image, wherein a change in visual content occurs between the switching image and a frame image previous to the switching image;
when there is at least one switching frame image, obtaining a target switching image which is closest to the target image in at least one switching frame image;
determining a time interval between the target switching image and the target image as the duration for displaying the visual content of the target image on the display panel.

21. The residual image compensation apparatus according to claim 20, wherein the comparing the at least one historical frame image and the target image to determine whether there is the switching image comprises:
obtaining an average grayscale map of the at least one historical frame image and the target image, wherein the average grayscale map comprises number n of grayscale blocks, wherein the number n is a positive integer greater than 1;
with respect to an average grayscale map of every two adjacent frame images in at least one historical frame image and the target image, determining a grayscale difference of grayscale blocks located at a same position in two average grayscale maps;
in the case that each of number n of grayscale differences is less than a preset threshold, determining that there is no switching image; otherwise, determining that a next one in the two adjacent frame images is a switching image.
